(19) United States
(12) Patent Application Publication
(10) Pub. No.: US 2026/0296906 A1
(43) Pub. Date: Oct. 1, 2026

(54) PROCESS FOR PRODUCING PHOSPHATE PRODUCTS AND SULFATE PRODUCTS

(71) Applicant: SUSPHOS B.V., Leeuwarden (NL)

(72) Inventors: Wiebe Ruurd ABMA, Leeuwarden (NL); Yuris Imano WERGES, Leeuwarden (NL)

(73) Assignee: SUSPHOS B.V., Leeuwarden (NL)

(21) Appl. No.: 19/480,470

(22) PCT Filed: May 1, 2024
(86) PCT No.: PCT/EP2024/061978

§ 371 Date: Oct. 31, 2025

(30) Foreign Application Priority Data
May 1, 2023 (NL) 2034733

(51) Int. Cl. C01C 1/242; C01B 25/232; C01B 25/28

(52) U.S. Cl. CPC C01C 1/242; C01B 25/232; C01B 25/28; C01P 2006/80

(57) ABSTRACT

A process for the preparation of a mixture of phosphate and sulfate products and/or a process for the production of phosphoric acid and its products. The process comprises reacting a phosphorus containing material with sulfuric acid in the absence of a solvent to form a reaction mixture comprising phosphoric acid, remaining sulfuric acid and residual material. The produced phosphoric acid and remaining sulfuric acid are separated from the residual material by adding ethanol, thereby forming a slurry of ethanol and solid residual material. The solid residual material is separated from the ethanol slurry and the acids with ammonia are reacted to produce ammonium phosphate and ammonium sulfate which are then separated from the ethanol; and/or the acids are separated from the ethanol to produce phosphoric acid and sulfate products, and the separated ethanol is recycled for use in the process.

### FIELD OF THE INVENTION

The present invention relates to a process for the preparation of a mixture of phosphate products and sulfate products. It furthermore relates to a process for production of phosphoric acid and its products. In addition, the invention relates to the production and uses of phosphoric acid and derivative salts, specifically from secondary phosphates, such as waste streams. The invention also relates to the production of ammonium phosphate salts combined with ammonium sulfate salts and to uses of the salts as, for example, fertilizer material, flame retardant, feed additive or nutrient.

### BACKGROUND OF THE INVENTION

In the production of phosphorus comprising products, resources of phosphor become more scarce nowadays. One of the reasons is that phosphorus is a major element in fertilizer, in animal feed, detergents and flame retardants. Phosphate is being mined from phosphate rock, or phosphorite, with China being the biggest producer. The grade of phosphate rock varies, phosphorite in the US for example contains from 28.5 to 29.0 percent P₂O₅.

Phosphate mining has a huge environmental impact. For each ton of phosphoric acid produced by the processing of phosphate rock, generally five tons of waste are generated. This waste takes the form of impure, useless, radioactive solid called phosphogypsum. Furthermore, byproducts of the phosphate mining process are for example fluoride, uranium and vanadium.

Phosphorus mines around the world are rapidly exhausting. There is thus a need in the art for a process which is more sustainable and able to recover phosphorus from for example waste resources, in particular from solid phosphorus sources. An example of a solid phosphorus source is struvite, which is a solid mineral which can be found in, for example, wastewater treatment units, wastewater from food processing industries, and other wastewater streams. Further solid phosphorus-containing waste resources include sewage sludge ash, meat and bone meal ash, and manure ash.

In general, phosphoric acid, the basic feedstock for phosphate fertilizers, is obtained through acid attack (sulfuric acid, or exceptionally hydrochloric acid) on phosphate rock (Ullmann's Technical Encyclopedia). This technology has been known for over a century and forms the basis of phosphoric acid and most derivative phosphate containing compounds, chiefly fertilizers but also technical, feed and food grade phosphates.

Ammonium sulfate, (NH₄)₂SO₄, is an inorganic salt with a number of commercial uses. The most common use is as a soil fertilizer for alkaline soils. It contains 21% nitrogen and 24% sulfur. In the soil the ammonium ion is released and forms a small amount of acid, lowering the pH balance of the soil, while contributing essential nitrogen for plant growth. It can also be used as an agricultural spray adjuvant for water-soluble insecticides, herbicides, and fungicides. There, it functions to bind iron and calcium cations that are present in both well water and plant cells. Ammonium sulfate has also been used in flame retardant compositions acting much like diammonium phosphate. As a flame retardant, it increases the combustion temperature of the material, decreases maximum weight loss rates, and causes an increase in the production of residue or char.

Ammonium sulfate can be made by treating ammonia with sulfuric acid, or it can be manufactured from gypsum (CaSO₄·2H₂O). In the latter case, finely divided gypsum is added to an ammonium carbonate solution. Calcium carbonate precipitates as a solid, leaving ammonium sulfate in the solution. Currently, resources of sulfur have not become scarce.

Methods for recovery of phosphorus in the form of phosphoric acid from solid phosphorus sources are known in the art. In general, they encompass leaching the phosphorus from solid phosphorus sources using an aqueous medium, followed by recovering the phosphorus from the leaching liquid.

For example, U.S. Pat. No. 3,298,782 describes digestion of phosphate rock with sulfuric acid, followed by extraction of the phosphate using a mixture of water-immiscible alcohol and an amine extractant.

FR 1480663 discloses a process of producing phosphoric acid, which comprises acidulating traditional phosphate rock. The process is an extension of the usual water-based production of phosphoric acid as performed on large scale by the industry. The process requires preheating of the phosphate rock, as supported by an example in FR 1480663 of the unacceptably low effectivity of the procedure if heating is not included. Heating of large masses of phosphate sources is costly, as far as investment and operational costs are concerned.

In WO 2020169708 a process is described wherein phosphoric acid is prepared from a solid phosphorus-containing material. The solid phosphorus-containing material is contacted with strong acid in a monophasic reaction medium comprising an organic solvent, to form a solution of phosphoric acid in organic solvent and remaining solid material, followed by separating the solution of phosphoric acid in organic solvent from the remaining solid material. It was found that phosphoric acid can be recovered from a solid phosphorus-containing material in high purity and efficiency via this process. A disadvantage of the process according to WO 2020169708 is that it requires the use of a strong acid diluted in an organic solvent for extraction. Due to dilution of the acid the phosphorous recovery becomes less effective for complex materials like sewage sludge ash. This makes such a process expensive to build and operate. Also, it is well known that such processes are sensitive to disruptions caused by, for example, varying input parameters.

WO 2022098241 is directed to a process for the production of phosphoric acid, comprising reacting a phosphorus-containing material with an acid, without organic solvent, thereby forming a reaction mixture comprising phosphoric acid, wherein said acid has a pKa of 3.5 or lower, followed by extracting phosphoric acid from the reaction mixture by adding organic solvent to the reaction mixture, thereby forming a phosphoric acid solution, wherein 20 wt. % or less of free water is added to the reaction mixture, based on the total weight of the reaction mixture, and the phosphorus-containing material comprises secondary raw material comprising phosphate.

In U.S. Pat. No. 3,663,168 a process is described to produce concentrated phosphoric acid from monocalcium phosphate that is present in single superphosphate or triple superphosphate by mixing monocalcium phosphate with methanol and an acidic sulfate. Monocalcium phosphate has been produced for many years in the form of single or triple superphosphate by the acidulation of phosphate rock. Many plants use sulfuric acid as the acidulation agent to produce single superphosphate. To produce the phosphoric acid a superphosphate material is mixed with methanol, followed by the addition of sulfuric acid or ammonium bisulfate. Fresh methanol was used for washing. A disadvantage of the process is that the methanol is extremely susceptible to degradation in the presence of concentrated sulfuric acid. A further disadvantage is that using methanol on an industrial scale is not straightforward due to its toxicity and handling safety.

The documents that are discussed above disclose processes that are complicated to implement.

Accordingly, there is a demand for an optimized process to manufacture high quality ammonium phosphate and ammonium sulfate and/or phosphoric acid that can be implemented more easily. There is furthermore a demand for a process to abstract phosphorus compounds that produce less by-products of low quality.

### SUMMARY OF THE INVENTION

It is an objective of the invention to address one or more of the disadvantages faced in the prior art. It is another objective of the invention to provide an alternative to biphasic extraction systems and avoid additional complexity. Further objectives include avoiding the formation of unwanted by-products. A particular objective is to provide an efficient and low-cost process for the production of phosphoric acid wherein fouling effects of process equipment is prevented.

Accordingly, the present invention relates to a process for the preparation of a mixture of phosphate and sulfate products, comprising:
a) reacting a phosphorus containing material with sulfuric acid in the absence of a solvent, thereby forming a reaction mixture comprising phosphoric acid, remaining sulfuric acid and residual material;
b) separating the produced phosphoric acid and remaining sulfuric acid from the residual material by adding ethanol, thereby forming a slurry of ethanol wherein the acids are dissolved and solid residual material;
c) separating the solid residual material from the ethanol wherein the acids are dissolved;
d1) reacting the acids with ammonia to produce ammonium phosphate and ammonium sulfate and separating the ammonium phosphate and ammonium sulfate from ethanol; and/or
d2) separating the acids from ethanol to produce phosphoric acid and sulfate products;
e) recycling the separated ethanol to step b) of the process.

Furthermore, the present invention relates to a product comprising at least 80 wt % of combined ammonium phosphate and ammonium sulfate, wherein the ratio of P to S is in the range of from 1:0.5 to 1:2, and at most 20 wt % of iron, aluminium and magnesium salts.

The present invention also relates to the use of such product as fertilizer material, flame retardant, feed additive or yeast nutrient.

### DETAILED DESCRIPTION OF THE INVENTION

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

The term “free water” as used herein, includes water that originates from a state wherein the water is not bound to, for example, solid matter, such as crystalline frameworks or phosphorus-containing material as described in this disclosure. In particular, the term refers to water that is added as such and/or as part of a solution. Unlike the traditional wet process, there is preferably very little, preferably 20 wt. % or less, more preferably 10 wt % or less, even more preferably no water added to the reaction mixture so that the phosphoric acid produced is of high concentration and high purity as described in this disclosure. In particular, very little free water, such as 10 wt % or less, more preferably 5 wt. % or less of free water, or no free water may be introduced into the process by the phosphorus-containing material and/or acid. Free water might be introduced to the reaction mixture by using a less concentrated acid, for example a 93% concentrated sulfuric acid.

The term “phosphoric acid” as used in this disclosure is meant to refer to phosphorus oxoacid. In particular, the term is used to refer to phosphoric acids, wherein each phosphorus atom is bonded to four oxygen atoms, one of them through a double bond, and arranged at the corners to form a tetrahedron-shaped molecule. The phosphorus may have an oxidation state of +5. In addition, the phosphoric acid may comprise one or more PO₄ tetrahedra, thereby forming linear or branched chains, cycles, or more complex structures. Examples of such phosphoric acids are orthophosphoric acid, pyrophosphoric acid, oligophosphoric acid, such as triphosphoric acid, super phosphoric acid and polyphosphoric acid.

The term “crystalline frameworks” as used herein, includes crystalline frameworks of, for example, a salt. The crystalline frameworks can originate, at least in part, from the phosphorus-containing material. Water can be found in crystalline frameworks. Such water can be removed from a crystalline framework by, for example, heating or solubilizing the crystalline framework. Hence, the phrase “water originating from crystalline frameworks”. The water content of compounds can be determined with thermogravimetric analysis, nuclear magnetic resonance spectroscopy, near infrared spectroscopy and even X-ray diffraction crystallography.

The term “phosphate products” as used herein, includes phosphoric acid as described above and phosphate salts that are being formed during the process of the invention. The phosphate salts include the various forms of ammonium phosphate, iron (II) phosphate and iron (III) phosphate and its polymorphs, possibly in their hydrated form, all forms of magnesium phosphate including monomagnesium phosphate, dimagnesium phosphate and trimagnesium phosphate, possibly in their hydrated form, all forms of zinc phosphate, all forms of calcium phosphate including orthophosphates, di- and monohydrogen phosphates, di- and polyphosphates, hydroxy- and oxo-phosphates, possibly in their hydrated form, all forms of silicon phosphate, possibly in their hydrated form, and aluminum, nickel or copper phosphates.

The term “sulfate products” as used herein, includes sulfuric acid and sulfate salts that are being formed during the process of the invention. The sulfate salts include all forms of ammonium sulfate, iron (II) sulfate and iron (III) sulfate and all its polymorphs, possibly in their hydrated form, all forms of magnesium sulfate, possibly in their hydrated form, all forms of zinc sulfate, all forms of calcium sulfate, possibly in their hydrated form, all forms of silicon sulfate, possibly in their hydrated form, and aluminum, nickel or copper sulfates.

The term “residual solid material” as used in this disclosure is meant to refer to the material that does not dissolve or react with sulfuric acid and remains solid or precipitates at least partly in ethanol. This residual solid material may include some of the sulfate products, such as zinc sulfate, calcium sulfate, silicon sulfate, and nickel or copper sulfates. The exact composition depends on the composition of the phosphorus containing material that is being used to start with. If for example sewage sludge ash is being used, more silica, iron sulfate and aluminium sulfate is present whereas if meat and bone meal ash is being used, more calcium sulfate is present. If dairy waste from whey processing is being used, more calcium sulfate is being present. The residual solid material, being rich in sulfate, Ca, Si, Fe and Al, can be used for example for the production of building materials. In the production of concrete, it may have positive properties which contribute to faster curing and/or acceleration of the reaction.

The innovative extraction process of the invention relates to monophasic extraction of phosphate to provide a straightforward and economically interesting extraction process that is ideally suited for producing phosphoric acid needed for, for example, fertilizers.

The process for the preparation of a mixture of ammonium phosphate and ammonium sulfate according to the invention comprises reacting a phosphorus containing material with sulfuric acid in the absence of a solvent. With the reaction between the phosphorus-containing material and the acid, a reaction mixture is formed that comprises phosphoric acid. The reaction is performed in the absence of an organic solvent, that is the reaction mixture may comprise 2 wt. % or less of organic solvent by total weight of the reaction mixture. Preferably, the reaction is performed in the absence of any organic solvent. The phosphorus-containing material is acidulated directly by adding the sulfuric acid to the material or vice versa. During acidulation, or acid attack, the structure of the phosphorus-containing material may at least partially be (chemically and/or physically) destroyed. By directly acidulating the phosphorus-containing material, high reaction temperatures may be reached that further drive the reaction forward in a short time span. This, in combination with a low free water content of the reaction mixture (e.g., 10 wt % or less, more preferably 5 wt. % or less), will significantly drive the reaction forward. Such destruction of phosphorus-containing material may be represented by a series of reactions between the acid and components of the phosphorus-containing material. With sulfuric acid, phosphate salts, such as calcium phosphate, will be converted at least partially to calcium sulfate and phosphoric acid. The advantage of this solvent free system is that a reaction mixture is being formed comprising phosphoric acid, remaining sulfuric acid and residual material. The formed reaction mixture has preferably the appearance of a slurry, between moist sand and coffee mud.

Besides sulfuric acid the acid may comprise one or more other inorganic acids. Examples of inorganic acids include nitric acid, hydrochloric acid, phosphoric acid, and perchloric acid. Sulfuric acid may be selected having any concentration, particularly of at least about 70%, preferably at least about 80%, more preferably at least about 96% or 98%. Nitric acid may have a concentration of about 68% or higher. Hydrochloric acid of any concentration may be selected, preferably of at least 30%. Phosphoric acid of any concentration may be selected, such as in the range of about 75-85%. Perchloric acid of any concentration may be selected, preferably of about 60% or higher, more preferably of about 70% or higher.

Preferably, the acid comprises besides sulfuric acid one or more selected from phosphoric acid, nitric acid and hydrochloric acid. More preferably, the acid comprises solely sulfuric acid, such as sulfuric acid having a concentration of about 96-98%.

The reaction between the phosphorus-containing material and sulfuric acid is a spontaneous exothermic reaction. The reaction typically does not require active heating. The temperature at which the reaction proceeds depends among others on the starting temperature, the heat generated in the reaction, the moisture content and the cooling/heating means applied externally to the reaction. The temperature should be sufficient to effectively convert the phosphorus-containing material to form phosphoric acid. Thereto, the reaction mixture may be actively heated. The temperature at which the reaction occurs may be between 50° C. and 250° C., more preferably between 90° C. and 210° C. At temperatures below 50° C., the reaction occurs slowly and may not reach completion. After the reaction, the temperature of the reaction mixture is typically allowed to drop, thereby reaching, for example, a temperature of at most about 100° C.

In the next step, step b), the produced phosphoric acid and remaining sulfuric acid are being separated from the residual material by adding ethanol, thereby forming a slurry of ethanol wherein the acids are dissolved and residual material. By using ethanol, products and by-products are separated in an uncomplicated manner. Separation problems encountered with traditional wet-processes are overcome now. By using ethanol, phosphoric acid and sulfuric acid are soluble therein, but the by-products, such as sulfates of calcium are only sparingly soluble, or insoluble. Aluminium, iron and magnesium sulfates are still fairly soluble in ethanol.

By using ethanol, problems encountered with other solvents are overcome. A disadvantage of the process according to WO2022098241 is that in the separation step in their examples acetone was added to the partly solidified cooled reaction mixture to extract phosphoric acid. The resulting reaction mixture contained solid residues and phosphoric acid dissolved in acetone. The solid residues were separated from the solvent via filtration. More acetone was added to the reactor and filtered, as further extraction and washing steps. The combined filtrates from all the filtration steps yielded a total of 6.5% H₃PO₄ in acetone. Acetone was evaporated on a solvent evaporator to obtain pure solvent-free phosphoric acid. The total yield of the pure phosphoric acid was 96% (calculated as phosphorus based on the phosphorus content in the starting material).

We now found that the acetone used to dissolve the formed phosphoric acid cannot be reused in the process as this results in colouring of the acetone, and eventually the product, to a kind of yellowish to dark brown or even black, because of the degradation of acetone. Degradation of acetone may even result in black tar like substances after several recycles, unusable in the process of the current invention.

A disadvantage of the process according to U.S. Pat. No. 3,663,168 is that in both the reaction step and in the separation step methanol is being used. Furthermore, fresh methanol was used for washing. A disadvantage of using methanol is that the methanol is extremely susceptible to degradation in the presence of concentrated sulfuric acid. Furthermore, using methanol on an industrial scale is not straightforward due to its toxicity and handling safety.

The use of ethanol results in a far better overall process; ethanol shows no or only very limited degradation, resulting in limited losses. In step e) of the process, recycling of the separated ethanol to step b) is executed. To make up for any losses of ethanol, preferably a maximum of 5 wt % of ethanol, more preferably a maximum of 2 wt % of ethanol relative to the total of recycled ethanol may be added. The separated ethanol that is being recycled might comprise some water. Preferably, the recycled ethanol comprises in the range of from 1 up to 20 wt % of water, more preferably in the range of from 2 up to 15 wt % of water, even more preferably in the range of from 3 to 10 wt % of water, even more preferably in the range of from 4 to 7 wt % of water. If the recycled ethanol comprises too little water, extra water might be added to the recycled ethanol.

By ethanol is being understood that as alcohol ethanol is being used in step b. Still traces of other alcohols might be present, in an amount of up to 20 wt %, preferably up to 10 wt %, more preferably up to 5 wt %, even more preferably up to 2 wt %. Most preferred is that besides ethanol no other alcohols are present.

The better results with ethanol were not expected. In WO2022098241 is described that particularly good extraction results have been obtained using solvents that do not form an azeotrope with water. Ethanol forms an azeotrope with water, thus the better results are unexpected.

In the following step the residual material is separated from the ethanol wherein the acids are dissolved. Separation techniques that are suitable for this step are filtration, centrifuge and/or decanting or a combination thereof. We furthermore found that water may improve filtration. Preferably, filtration is done using shear enhanced filtration like using a nudge filter, a dynamic filter press and/or a bocross filter. When necessary, pre-coats or filter aids can be applied to improve the filtration. Separation may be followed by reslurrying with ethanol and separating to increase recovery, and again if so required. Preferably ethanol is moved countercurrent in this processing. Preferably clean solvent is moved after separation to the previous step for reslurrying.

The addition of water may improve filtration and/or centrifugation by causing enhanced flocculation and/or coagulation and/or crystallization. This water can be added to ethanol, preferably in ratios between 0.05 up to 0.7 water to the phosphorus containing material, more preferably in ratios between 0.05 up to 0.3 water to the phosphorus containing material. It is believed that the addition of certain amounts of water causes the formation of magnesium sulfate, calcium sulfate, aluminium sulfate and/or iron sulfate with x molecules of crystal water, which is easier to filter, wherein x is preferably an integer between 1 and 24. The sulfate salts with up to their maximum of crystal water have superior properties with respect to filtration.

Water can also be added at the start of the reaction, preferably by using a more diluted sulphuric acid. It can also be added at the end of the acidulation reaction, during the separation of the phosphoric acid. Water might furthermore be added before separation of the solids and the liquids present.

Improvement of solid content will reduce energy for drying, as more solids results in less solvent and less solvent needs to be evaporated. So, if the solid-liquid separation results in a drier cake less solvent needs to be evaporated.

In step d1), the acids react with ammonia to produce ammonium phosphate and ammonium sulfate and they are separated from ethanol. No or very little water is present as the product easily dissolves in water. Preferably, the maximum of water present is 20 wt %, preferably 10 wt %, more preferably 8 wt %. The precipitate can be separated from ethanol by readily available technologies. Ammoniation (treatment with ammonia and/or a derivative thereof) of the ethanol wherein the acids are dissolved may result in the formation of a mixture of ammonium phosphate and ammonium sulfate precipitate which may be readily removed by filtration. The product may comprise metals like Mg, Fe and Al. The precipitate may further be dried or washed and dried to recover ethanol and produce solids that are suitable for commercial sale. Vacuum drying with vapour recovery is preferably being used to further dry the precipitate. This water-soluble compound is, for example, a highly valuable fertilizer. The high degree of insolubility of ammonium phosphates and ammonium sulfates in ethanol makes such a precipitation markedly different from precipitation in traditionally used watery systems, where ammonium phosphates and ammonium sulfates are highly soluble and need to be crystallized by evaporating large amounts of water. This was an unexpected result, as ethanol forms an azeotrope with water. Whereas the precipitation of ammonium phosphates with traditional water-based systems is energy inefficient (energy intensive), the invention allows ammonium phosphates and ammonium sulfates to easily precipitate with high purity. In addition, precipitation of ammonium phosphates with traditional water-based systems results in highly contaminated mother lye comprising significant amounts of phosphate that can neither be used to produce pure ammonium phosphate nor discarded because of its value. The recovered ethanol according to the invention is of such a good quality that it can be reused in step b), preferably multiple times.

Alternatively or in addition to step d1), the acids are separated from ethanol to produce phosphoric acid and sulfate products in step d2). Also here, the recovered ethanol is of such a good quality that it can be reused in step b), preferably multiple times. Step d2) is preferred over step d1).

Advantageously, in step a) an excess amount of sulfuric acid towards cations present in the phosphorus containing material is added. More advantageously the excess amount of sulfuric acid towards cations present in the phosphorus containing material is in the range of from 1.01 up to 1.5, preferably in the range of from 1.05 up to 1.3. By using an excess amount of sulfuric acid towards cations present in the phosphorus containing material, the conversion of phosphorus in the phosphorus containing material is higher, even at such a level that a conversion of at least 0.80 was reached. The cations present are generally Ca, Fe, Al, Mg and K. Other cations may be present in lower amounts as trace materials.

The process may further comprise a step of cooling the reaction mixture prior to the extraction. Preferably, the cooling step comprises external cooling. With the cooling step, dissolved salts may crystallize such that the filtration of precipitates becomes easier and/or mixing of the organic solvent with the reaction mixture is made possible without losing a significant part of the solvent intended for the extraction by evaporation. Preferably, the reaction mixture is cooled before step b) via a jacket or by quenching with a liquid, preferably by quenching with ethanol.

Preferably, ethanol and/or additional ethanol is added to the reaction mixture at a temperature at or below 78° C. at atmospheric pressure, more preferably at a temperature at or below 55° C. at atmospheric pressure. This temperature can be reached by the use of external cooling or by letting the mixture cool down by waiting a certain time.

The use of another alcohol like n-propanol or isopropanol might be considered, possibly as additional alcohol, but is not preferred. The use of mixtures of more than 2 different alcohols might also be considered.

Advantageously, besides ethanol water is added to the reaction mixture in step b) or in step c). The addition of water is advantageous for the formation of the sulfate salts. To form these, water is being built in the sulfate salt crystal framework up to 6 water molecules in for example iron (III) sulfate hexahydrate, 7 water molecules for magnesium (II) sulfate heptahydrate, and 2 water molecules in case of calcium (II) sulfate dihydrate. Water addition may also be advantageous to depolymerize polyphosphoric acid. The amount of water advantageously added is determined per kind of source material. Depending on the components and form of Me, being for example Ca, Fe, Mg, and/or Al in for example sewage sludge ash, MeSO₄·xH₂O is formed, where x depends on the metal. Advantageously, the amount of water is sufficient to make up for all crystal water x, and almost no free water is left in the ethanol after formation of the sulfate salts.

The invention is applicable to the extraction of phosphate from, for example, secondary raw material comprising phosphate, and phosphate rock. The invention can provide local markets with a supply of highly pure and concentrated phosphoric acid, phosphate derivatives and sulfate derivatives as defined in this disclosure, without relying on mines that may be far away and whose supply is difficult to secure. The invention makes it available to process large sources of, for example, recycled phosphorus, such as struvite and/or sewage sludge ash, for the extraction of phosphate.

The phosphorus-containing material may comprise secondary raw material comprising phosphate, and/or phosphate rock. In particular, the phosphorus-containing material comprises secondary raw material comprising phosphate. Secondary raw material comprising phosphate can be any suitable poor, used, rejected and/or depleted material, comprising phosphate, such as wastes from the agri-food industry, sludge, etc., for further use. For example, the secondary phosphate-containing material may be provided from a phosphate recovery operation. Preferably, the phosphorus-containing material comprises one or more selected from apatite, calcium phosphate, struvite, vivianite, sewage sludge ash, meat and bone meal ash, dairy waste from whey processing and manure ash, more preferably one or more selected from struvite, vivianite, sewage sludge ash, meat and bone meal ash, calcium phosphate, dairy waste from whey processing and manure ash. Even more preferably, the phosphorus-containing material comprises sewage sludge ash, meat and bone meal ash, and/or dairy stream from whey processing. We found that the process of the invention is especially suitable for phosphorus-containing material that have undergone heat treatment to convert the original material to its ashes. Most preferred is sewage sludge ash.

With the process of the invention, it is preferred to have a molar ratio between sulfuric acid, calculated as protons, and phosphorus in the phosphorus-containing material, calculated as P, of 1:1 or more, preferably 1:1 to 15:1. It is even more preferred to have a molar ratio between sulfuric acid, calculated as protons, and phosphorus in the phosphorus-containing material, calculated as P, of 3:1 to 12:1. If one of the ashes is being used, sewage sludge ash or meat and bone meal ash, it is even more preferred to have a molar ratio between sulfuric acid, calculated as protons, and phosphorus in the phosphorus-containing material, calculated as P, of 4:1 to 8:1, the exact ratio depending on the exact composition of the ashes.

The inventors found that by acidulating phosphorus-containing material with sulfuric acid, in particular secondary phosphates (secondary raw material comprising phosphate) that comprise, for example, iron and/or aluminum, such as sewage sludge ashes, especially in the absence of water, autogenous heating occurs, which is sufficient to allow high-yield conversion of the material to phosphoric acid and remaining sulfuric acid. Subsequently, the phosphoric acid and sulfuric acid can be selectively extracted using ethanol. As a result, the invention avoids the complexity and costs of traditional processes, such as those described in the prior art mentioned in this disclosure. Thus, advantageously, the phosphoric acid is formed by a spontaneous, exothermic reaction between the phosphorus-containing material and sulfuric acid.

Preferably, 20 wt. % or less of free water by total weight of the reaction mixture is added to the reaction mixture. The amount of free water added to the reaction mixture may be 15 wt. % or less, such as 14 wt. % or less, 13 wt. % or less, 12 wt. % or less, 11 wt. % or less, or 10 wt. % or less. Preferably, the amount of free water added to the reaction mixture is 5 wt. % or less, such as 4 wt. % or less or 3 wt. % or less. More preferably, the amount of free water added to the reaction mixture is 2 wt. % or less, such as 1 wt. %. Even more preferably, essentially no free water is added to the reaction mixture (i.e., about 0 wt. % of the reaction mixture). Without being bound by theory it is believed that a small amount of free water added to the reaction mixture contributes to obtaining soluble phosphoric acid(s) and/or phosphate compound(s) in high yields and purities as described in this disclosure. One of the reasons for adding 20 wt. % or less of free water to the reaction mixture is the desirability of obtaining phosphoric acid in high concentrations as described in this disclosure, which can, for example, be shipped at a minimum of expense. In addition, by adding such a low amount of free water to the reaction mixture, the extraction step results inter alia in a re-usable solvent for a subsequent cycle with a desirable lower water content.

Preferably, the amount of free water is 10 wt. % or less, more preferably 5 wt. % or less, even more preferably 2 wt. % or less. Besides free water, water may be present in the reaction mixture as it originally resided in, for example, crystalline frameworks. Depending on, for example, the composition of the phosphorus-containing material, the amount of water from crystalline frameworks may vary. Accordingly, the reaction mixture may comprise near zero weight percent by total weight of the reaction mixture, for example, in the case of sewage sludge, or more, such as at least 30 wt. % of water originating from crystalline frameworks. In particular, the reaction mixture may comprise 40 wt. % or more of water from crystalline frameworks, such as 45 wt. % or more or 50 wt. % or more.

Free water can also reside in the phosphorus-containing material. The phosphorus-containing material and/or the acid may comprise free water. The amount of free water in either may vary, depending on the composition of the phosphorus-containing material and/or the acid. In particular, the phosphorus-containing material and the acid combined may comprise 20 wt. % or less of free water by the total combined weight of the phosphorus-containing material and acid. The phosphorus-containing material and acid combined may comprise 15 wt. % or less of free water, such as 13 wt. % or less or 11 wt. % or less. Preferably, the amount of free water in the phosphorus-containing material and acid combined is 10 wt. % or less, such as 9 wt. % or less, 8 wt. % or less, 7 wt. % or less, or 6 wt. % or less. More preferably, the amount of free water in the phosphorus-containing material and acid combined is 5 wt. % or less, such as 4 wt. %. It is believed that such amounts of free water in the phosphorus-containing material and acid combined contribute to the direct acidulation of the phosphorus-containing material and an exothermic reaction between said material and the acid. As such, less heat or even no heat is required to drive the acidulation reaction. Hence, by keeping the amount of free water low in the phosphorus-containing material and acid combined, the reaction between said material and acid may become spontaneous and/or exothermic.

By use of ethanol instead of water the formation of compounds like silicagel is prevented. Silicagel can have detrimental fouling effects in process equipment. Water induces hydrolyzation of silica resulting in polymerization. Free water present in the solvent should therefore be minimized and preferably avoided.

The sulfuric acid used in the process of the invention is preferably a technical grade sulfuric acid. Preferably, the concentration of sulfuric acid is more than 70%, more preferably more than 80%, even more preferably more than 90%, most preferably at least 96%.

The process may further comprise adding phosphoric acid. The phosphoric acid may be added either prior to extraction step b), such as to step a), for example, to the reaction mixture under step a); between steps a) and b); and/or during extraction step b), such as prior to adding ethanol to the reaction mixture, at the same time as adding ethanol and/or after adding ethanol. The phosphoric acid may comprise entirely of phosphoric acid formed by the process or in part. For example, the phosphoric acid may comprise 5 wt. % or more of the formed phosphoric acid by total weight of the phosphoric acid, such as 10 wt. % or more, 15 wt. % or more, 20 wt. % or more, 25 wt. % or more, or 30 wt. % or more. The phosphoric acid may comprise 95 wt. % or less of the formed phosphoric acid by total weight of the phosphoric acid, such as 90 wt. % or less, 85 wt. % or less, 80 wt. % or less, 75 wt. % or less, or 70 wt. % or less. In particular, the phosphoric acid comprises 10-90 wt. % of the formed phosphoric acid, such as 20-80 wt. % or 30-70 wt. %. By adding phosphoric acid to the process, for example, the ratio between solids and liquids, such as those described in this disclosure, in the reaction mixture may be favourably affected, thereby improving the homogeneity of the reaction mixture and/or the extraction of phosphoric acid.

After the phosphoric acid and sulfuric acid are extracted from the reaction mixture, the acid solution may still additionally contain small amounts of sulfate. Extraction is preferably done by evaporating ethanol in step d2), whereby the ethanol is collected and recycled to the process in step e) to step b). Solids that may reside in the acid solution after extraction may primarily be composed of calcium sulfate with small amounts of other impurities found in the phosphorus-containing material. Any conventional filtration apparatus may be used to separate the solution containing the phosphoric acid from the solids. Consecutive washing steps may be further performed to allow optimal separation of the dissolved phosphoric and sulfuric acid from the solids. It is desired to produce phosphoric acid and sulfuric acid of high purity. The amount of sulfate in the solution may be reduced by partial evaporation of the ethanol. With that procedure sulfate salts precipitate, which may then be removed by further filtration. However, since the amount of sulfate in the solution may be minute, the further purification step is not necessary for every purpose. Because of the high selectivity of the extraction process, most other components present in the phosphorus-containing material, including silica, calcium, copper, zinc and iron, are not extracted in appreciable amounts, and are filtered off as solids together with the sulfates in the primary filtration step.

The invention allows for the production of highly concentrated phosphoric acid and sulfuric acid, in particular when the water content during the acidulation reaction is kept at a minimum. The highly concentrated phosphoric acids include, for example, super phosphoric acid and polyphosphoric acid. Traditional methods for producing such phosphoric acids typically require either significant amounts of thermal energy to drive out water from ordinary phosphoric acid, or the addition of phosphorus pentoxide as made through the energy-intensive white phosphorus synthesis route. To obtain phosphoric acid from the solution, evaporation of the solvent and recovery for subsequent use is preferred. Upon distillation or evaporation of the solvent, phosphoric acid of different concentrations phosphorus pentoxide (P₂O₅) may result. Phosphoric acid may be obtained having at least 35 wt % P₂O₅, for example between about 35 wt % P₂O₅ and about 70 wt % P₂O₅, such as between about 35 wt % P₂O₅ and about 65 wt % P₂O₅. The phosphoric acid may have a P₂O₅ concentration of 40 wt % or more, such as 45 wt % or more, 50 wt % or more, 55 wt % or more, or 60 wt % or more, and/or, for example, 70 wt % or less, 65 wt % or less. For example, the phosphoric acid may have a P₂O₅ concentration of 40-70 wt %, such as 55-70 wt %, 60-65 wt %. More preferably, the phosphoric acid has 60 wt % or more of P₂O₅, such as 65 wt % or more, for example 60-70 wt %. The concentration of the phosphoric acid depends inter alia on the amount of water added or present in the reaction mixture. The phosphoric acid may readily be further concentrated by, e.g., heating the acid to drive off water.

After the phosphoric acid and sulfuric acid are extracted from the reaction mixture, they are reacting with ammonia to produce ammonium phosphate and ammonium sulfate. The invention is also directed to the obtained product, comprising at least 80 wt % of combined ammonium phosphate and ammonium sulfate, wherein the ratio of P to S is in the range of from 1:1 to 1:2, and at most 20 wt % of iron, aluminium and magnesium salts.

Preferably, the iron, aluminium and magnesium salts are hydrated iron (II) sulfate, hydrated aluminium sulfate and hydrated magnesium sulfate or phosphates.

In the most preferred embodiment of the invention ethanol is used as solvent and the acids are converted to their ammonium salt products: thus, the process for the preparation of a mixture of phosphate and sulfate products, comprising:
a) reacting a phosphorus containing material with sulfuric acid in the absence of a solvent, thereby forming a reaction mixture comprising phosphoric acid, remaining sulfuric acid and residual material;
b) separating the produced phosphoric acid and remaining sulfuric acid from the residual material by adding ethanol, thereby forming a slurry of ethanol wherein the acids are dissolved and solid residual material;
c) separating the solid residual material from the ethanol wherein the acids are dissolved;
d) reacting the acids with ammonia to produce ammonium phosphate and ammonium sulfate and separating the ammonium phosphate and ammonium sulfate from ethanol;
e) recycling the separated ethanol to step b) of the process.

Animal feed may be provided by adding a calcium compound to the organic solvent in the form of a source of calcium ions to precipitate calcium phosphate. Sodium hydroxide neutralization of the extraction solvent may result in the precipitation of sodium phosphates, which are products of considerable commercial interest. Neutralization with potassium compounds, such as potassium hydroxide, may yield precipitate of potassium phosphate, which can be useful in technical and food applications. Accordingly, it can be seen that phosphoric acid can readily be separated from the solution by, for example, evaporation and/or precipitation in the form of a salt. Hence, the process may further comprise a step of adding a reactant, such as any of the above described reactants, to the phosphoric acid solution that reacts with phosphoric acid to form a phosphate salt. The reactant may be selected from calcium compounds; sodium compounds; and/or potassium compounds, preferably any such compound as described in this disclosure. For example, the process may further comprise a step of ammoniating the phosphoric acid solution to form an ammonium phosphate salt. Thus, there is also provided ammonium phosphate salt obtainable by the process, wherein the process further comprises the step of ammoniating the phosphoric acid solution to form the ammonium phosphate salt.

The mixture of ammonium phosphate and ammonium sulfate may comprise impurities, such as those that can be found in the phosphoric acid, including metals, e.g., aluminium, magnesium, iron and calcium, fluoride, unreacted phosphoric acid, solvent, acid etc. In particular, the mixture of ammonium phosphate and ammonium sulfate comprises 20 wt. % or less of impurities based on the total weight of the ammonium phosphate and ammonium sulfate. Preferably, the mixture of ammonium phosphate and ammonium sulfate comprises 10 wt % or less of impurities, such as 5 wt % or less. More preferably, the mixture of ammonium phosphate and ammonium sulfate comprises 3 wt % or less of impurities, such as 2 wt % or less, or even 1 wt % or less.

The invention is furthermore directed to the use of combined ammonium phosphate and ammonium sulfate, wherein the ratio of P to S is in the range of from 1:0.5 to 1:2, preferably in the range of from 1:1 to 1:2, and at most 20 wt % of iron, aluminium and magnesium salts, as fertilizer material, flame retardant, feed additive or yeast nutrient.

The invention also provides the use of ammonium phosphate salt obtainable by a process as defined in this disclosure, as fertilizer material, flame retardant, feed additive, or yeast nutrient (e.g., for winemaking). The process may be in accordance with the process in the first aspect of the invention, and further comprises adding a reactant to the phosphoric acid solution that reacts with phosphoric acid to form an ammonium phosphate salt. The process may be in accordance with the process for the production of ammonium phosphate salts provided in this disclosure. In particular, monoammonium phosphate salt and/or diammonium phosphate salt may be used as fertilizer material, whereas mono- or diammonium phosphate salt may be used as a precursor to produce flame retardants, such as ammonium polyphosphate, or as a flame retardant.

The following, non-limiting examples are provided to illustrate the invention.

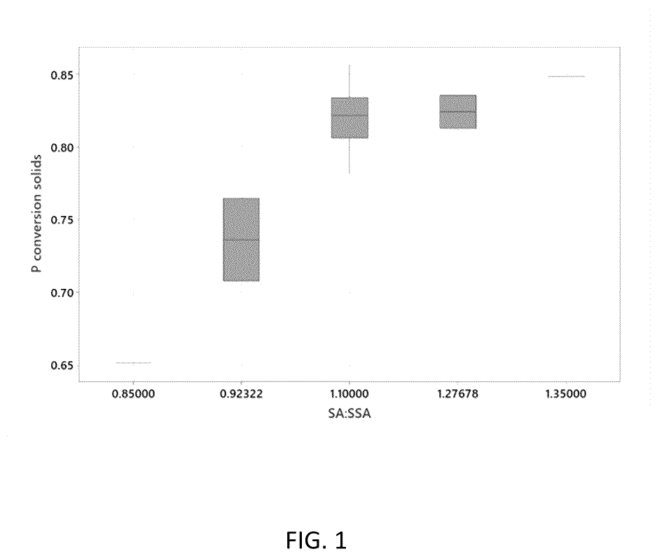

FIG. 1 illustrates a boxplot of the phosphorus conversion where sewage sludge ash is the starting phosphorus containing material, as a function of the different sulfuric acid to sewage sludge ash ratios.

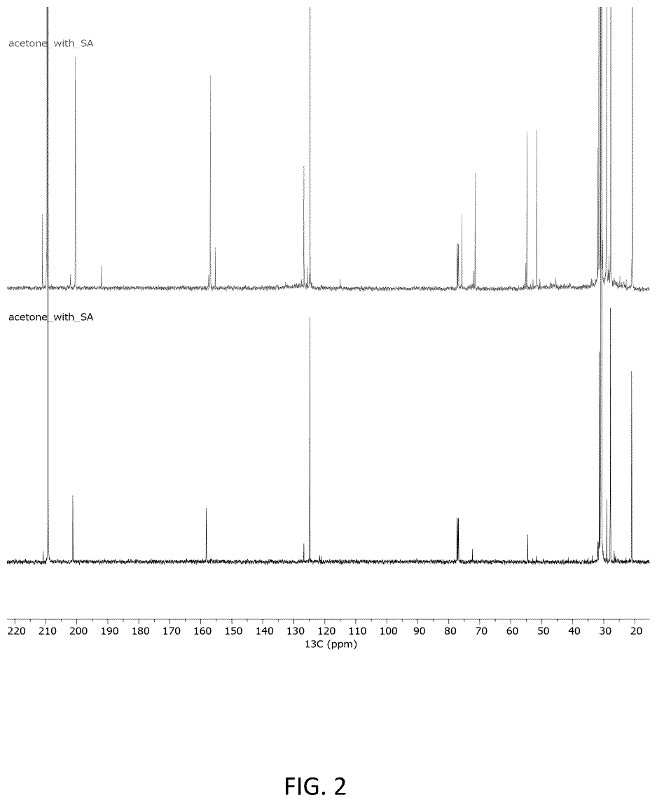

FIG. 2 illustrates 2 NMR spectra of acetone after acidulation, demonstrating that after 4 days clear degradation peaks of acetone are visible.

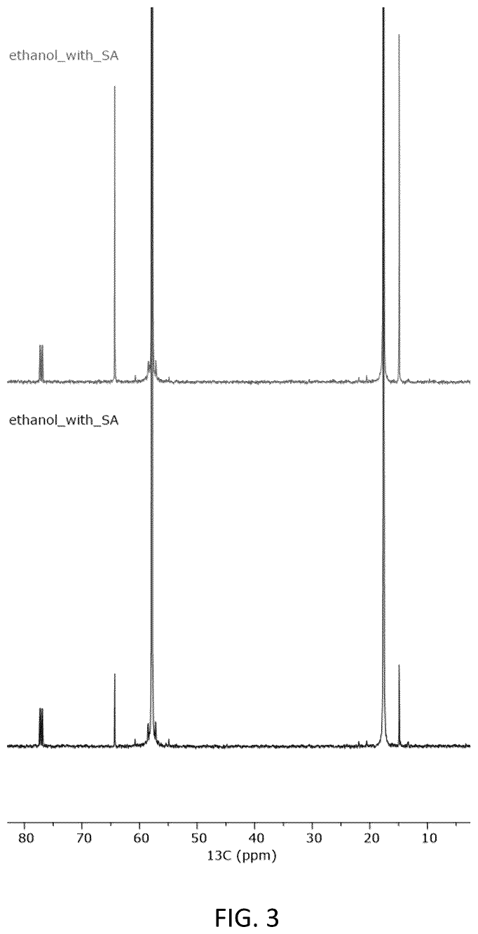

FIG. 3 illustrates 2 NMR spectra of ethanol after acidulation, demonstrating that after 4 days no degradation peaks of ethanol are visible.

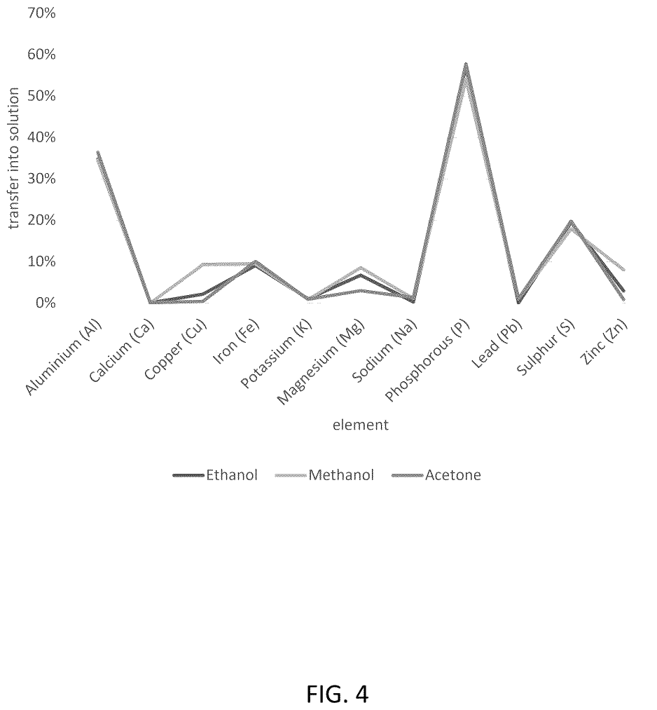

FIG. 4 illustrates the results of the phosphoric acid and remaining solid samples that were analyzed by ICP analysis for methanol, ethanol and acetone as solvent. The comparison is on element yield into the solution.

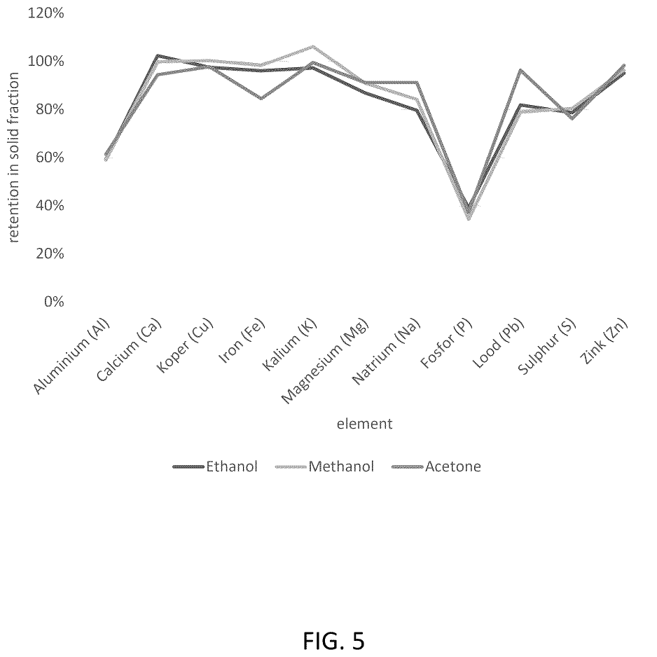

FIG. 5 illustrates the results of the phosphoric acid and remaining solid samples that were analyzed by ICP analysis for methanol, ethanol and acetone as solvent. The comparison is on element retained in solid fraction.

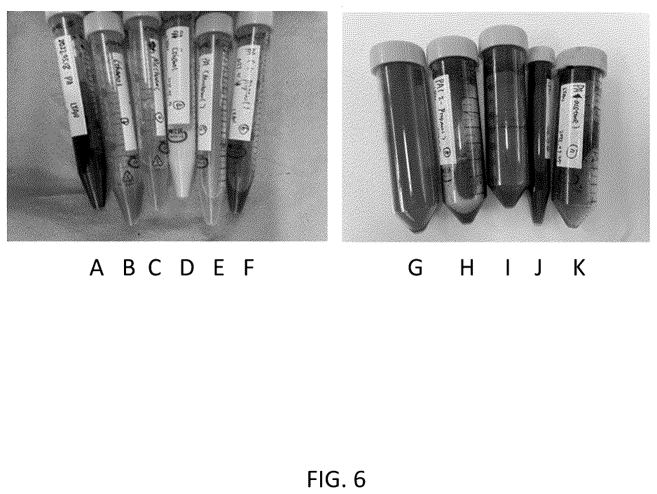

FIG. 6 illustrates the results the phosphoric acid samples of the various tests.

### EXAMPLES

### Example 1a: Lab Experiment

In a beaker 50 g of sewage sludge ash (SSA) was introduced. 53 g of 96% sulfuric acid (SA) was added to the beaker. The content of the beaker was mixed for 10 minutes. The temperature increased rapidly to 180° C. and subsequently started declining. The mixture was subsequently cooled to 50° C. by using a water bath before adding 250 ml ethanol. The resulting slurry was mixed with an ULTRA-TURRAX® for 10 minutes. The slurry was poured into a buchner funnel over a paper filter to separate the solution of phosphoric acid from the solids by vacuum filtration. After the top of cake had become dry another 50 ml ethanol was poured over the filter cake to increase the P recovery from the solids. This was repeated a second time. The measured P removal from solids was 83%. In FIG. 1 the P recovery from solids vs the SA:SSA ratio is depicted. From the figure it can be concluded that a 80% recovery from SSA can be reached via this procedure applying a SA:SSA ratio of 1:1.

### Example 1b: Lab Experiment

The lab experiment was repeated using three types of ore samples (Egypt rock) each having a different percentage of P₂O₅, these being 13.6% P₂O₅ (Sample A), 18.6% P₂O₅ (Sample B) and 19.6% P₂O₅ (Sample C). The received ore was initially ground to the consistency of a fine powder, to be used as the input feed. With this fine powder, sulfuric acid (SA) was added in a 1:1 ratio, at the scale of 10 grams of SA to 10 grams of ore powder. Upon addition of SA, there was substantial amount of ‘bubbling’ and a foam-like substance formed where the acid was in contact with the ore powder (possibly due to the trapping of gases formed) and significant amounts of heat was released. After continuous mixing, the reaction was complete in approximately 10 minutes, indicated by homogeneity of the mixture. This is referred to as the acidulate. To determine the amount of phosphate extracted, the acidulate was washed and separated from the remaining solids. To do this, the acidulate was suspended in a dissolver (ethanol-EtOH) and centrifuged. The liquid EtOH portion, now containing the extracted phosphoric acid (PA), was separated from the solid residue, referred to as a cake. In order to measure the amount of PA left in the cake, the cake was dried in an oven overnight and ground to a fine powder-referred to as crude salts (CS). The measured P removal from solids was 40% for sample A, 42% for sample B and 54% for sample C.

### Example 2: Pilot Plant Scale

In the acidulation reactor 8 kg of sewage sludge ash was introduced. Whilst mixing 4.41 of 96% sulfuric acid was introduced over 10 minutes. Due to the reaction that unlocks phosphate as phosphoric acid from the ash, the temperature increased from ambient to 134° C. 12 minutes after the dosing of sulfuric acid was stopped, cooling of the reactor was started by flowing water through the cooling mantle. When the temperature was below 50° C. after 48 minutes cooling, ethanol was added whilst intensely mixing to dissolve the produced phosphoric acid. The resulting slurry was transferred over a filter to separate the solution of phosphoric acid and residual sulfuric acid still present from the solids to be transferred to the next step. By washing the filtercake for a second time and filtering the solids, over 80% of P had been removed from the solids. In the next step the phosphoric acid solution was reacted with ammonia to produce ammonium phosphate and ammonium sulfate which was separated from the ethanol by filtration. The ethanol was reused again to dissolve phosphoric acid in the acidulation reactor.

By using ethanol as solvent a clear liquid is obtained without significant coloring/visible degradation products. The ethanol was used multiple times. The experiment was also performed by using acetone as the solvent. When using for instance acetone as solvent, the liquid turned brown and eventually black due to degradation. By measuring the composition of the solvent mixture after acidulation by NMR after 4 days it clearly shows that acetone shows degradation (peaks) whilst these are absent in case of using ethanol as solvent. The results are presented in FIGS. 2 and 3.

### Example 3: Comparison of Degradation of Different Solvents

Before the start of the experiment, a certain amount of sewage sludge ash and sulfuric acid were mixed in a ratio of 1 to 0.73 and stirred to prepare acidulate. Since acidulation is an exothermic process, acidulate was cooled to room temperature before experiments to be conducted. The beaker was then filled with 23 g of acidulate and 70 ml of solvent. The content of the beaker was mixed with an immersion blender for five minutes. The mixed samples were subjected to solid-liquid separation by paper filtration. Recording the period of solid-liquid separation is necessary. The residual solids on the paper filter were heated on a heating plate to help the remaining solvent evaporate. The remaining liquid after paper filtration is mainly solvent and extracted phosphoric acid. Heat is used on the liquid to allow the solvent to evaporate, leaving the phosphoric acid sample. The phosphoric acid and remaining solid samples were analyzed by ICP analysis.

The results of the analysis are shown in FIG. 4 and in FIG. 5. Results show the yields in ethanol, methanol and acetone to be similar. Whilst degradation of ethanol and methanol is visibly negligible, acetone and propanol show heavy degradation and the formation of black product. This is clearly visible in FIG. 6. FIG. 6 shows the results of the phosphoric acid samples of the various tests. De letters stand for the various test results with various solvents:
A—Acetone
B—Ethanol
C—Methanol
D—Ethanol
E—Methanol
F—1-Propanol
G—1-Propanol
H—2-Propanol
I—2-Propanol
J—Acetone
K—Acetone

It is clearly visible that ethanol and methanol give far better results with respect to degradation, the products with acetone, and 1-propanol or 2-propanol clearly show degradation and a dark product.

1. Process for the preparation of a mixture of phosphate and sulfate products, comprising:
a) reacting a phosphorus containing material with sulfuric acid in the absence of a solvent, thereby forming a reaction mixture comprising phosphoric acid, remaining sulfuric acid and residual material;
b) separating the produced phosphoric acid and remaining sulfuric acid from the residual material by adding ethanol, thereby forming a slurry of ethanol wherein the acids are dissolved and solid residual material;
c) separating the solid residual material from the ethanol wherein the acids are dissolved;
d1) reacting the acids with ammonia to produce ammonium phosphate and ammonium sulfate and separating the ammonium phosphate and ammonium sulfate from ethanol; and/or
d2) separating the acids from ethanol to produce phosphoric acid and sulfate products;
e) recycling the separated ethanol to step b) of the process.

2. Process according to claim 1, wherein in step a) an excess amount of sulfuric acid towards phosphorus in the phosphorus containing material is added.

3. Process according to claim 2, wherein the excess amount of sulfuric acid towards cations present in the phosphorus containing material is in the range of from 1.01 up to 1.5.

4. Process according to claim 1, wherein the reaction mixture is cooled before step b) via a jacket or by quenching with a liquid.

5. Process according to claim 1, wherein ethanol is added to the reaction mixture at a temperature at or below 78° C. at atmospheric pressure.

6. Process according to claim 1, wherein besides ethanol water is added to the reaction mixture in step b) or in step c).

7. Process according to claim 1, wherein ethanol is added to the reaction mixture in step b).

8. Process according to claim 1, wherein the phosphorus-containing material comprises one or more selected from apatite, calcium phosphate, struvite, vivianite, sewage sludge ash, meat and bone meal ash, dairy waste stream from whey processing and manure ash.

9. Process according to claim 8, wherein the phosphorus-containing material comprises sewage sludge ash, meat and bone meal ash, and/or dairy waste from whey processing.

10. Process according to claim 1, wherein a molar ratio between sulfuric acid, calculated as protons, and phosphorus in the phosphorus-containing material, calculated as P, is 1:1 or more.

11. Process according to claim 10, wherein the molar ratio is 3:1 to 12:1.

12. Process according to claim 1, wherein the phosphoric acid is formed by a spontaneous, exothermic reaction between the phosphorus-containing material and sulfuric acid.

13. Process according to claim 1, wherein the amount of free water is 10 wt. % or less.

14. Process according to claim 1, wherein the sulfuric acid is a technical grade sulfuric acid.

15. Product comprising at least 80 wt % of combined ammonium phosphate and ammonium sulfate, wherein the ratio of P to S is in the range of from 1:0.5 to 1:2, and at most 20 wt % of iron, aluminum and magnesium salts.

16. Product comprising at least 80 wt % of combined phosphoric acid and sulphuric acid and/or sulphate, wherein the ratio of P to S is in the range of from 1:0.5 to 1:2, and at most 20 wt % of iron, aluminum and magnesium salts.

17. Product according to claim 15, wherein the iron, aluminum and magnesium salts are iron (III) sulfate, aluminum sulfate and magnesium sulfate.

18. A method of using the product according to claim 15, the method comprising the step of introducing the product into a fertilizer material, flame retardant, feed additive or yeast nutrient composition.
